(19) United States
(12) Patent Application Publication
(10) Pub. No.: US 2025/0384025 A1
(43) Pub. Date: Dec. 18, 2025

(54) METHOD OF AUTOMATICALLY PROCESSING MISSING VALUE IN DATA AND DATA PROCESSING SYSTEM

(71) Applicants: Inventec (Pudong) Technology Corp., Shanghai (CN); Inventec Corporation, Taipei (TW)

(72) Inventors: Wei-Chao Chen, Taipei (TW); Ming-Chi Chang, Taipei (TW); Shu-Huei Yang, Taipei (TW)

(73) Assignees: Inventec (Pudong) Technology Corp., Shanghai (CN); Inventec Corporation, Taipei (TW)

(21) Appl. No.: 18/809,366

(22) Filed: Aug. 20, 2024

(30) Foreign Application Priority Data
Jun. 12, 2024 (CN) 202410758235.0

(51) Int. Cl. G06F 16/23; G06F 16/215

(52) U.S. Cl. CPC G06F 16/2365; G06F 16/215

(57) ABSTRACT

A method of automatically processing missing value in data is provided. The method includes providing a data set including a plurality of data points and determining data points with missing value and data points without missing value in the data set, selecting the data points without missing value from the data set to form a first data subset without missing value, for each data point with missing value, iteratively performing a first outlier deletion operation to determine whether to delete or impute the data point with missing value based on the first data subset and a predetermined threshold value, and based on determining that the data point with missing value needs to be imputed, iteratively performing a second outlier deletion operation to determine optimum filling values for the data points with missing value.

### BACKGROUND OF THE INVENTION

### 1. Field of the Invention

The present invention relates to a method of automatically processing missing value in data and a data processing system, and more particularly, to a method of automatically processing missing value in data and a data processing system capable of determining optimum filling value for data with missing value.

### 2. Description of the Prior Art

With the rapid development of technology, smart healthcare has gradually become one of the important issues in future medical developments. Medical-related researches are typically verified and confirmed by conducting clinical trials. However, there will almost always be some missing values in data. Missing values may result from system malfunction during data collection or human error during data pre-processing. Thus, it is important to deal with missing values before analyzing data since ignoring or omitting missing values may result in biased or misinformed analysis. There are several conventional methods to handle missing values in data. One is simply to delete missing values in data. Another One is to perform imputation operations on missing values. For example, conventional method determines whether to delete missing values in data or perform the imputation operation for the missing value based on the number of missing values. However, conventional method decides how to handle the missing value depending on the amount of data determined by subjective judgment of human. If the amount of data without missing value is sufficient, all data with missing value will be deleted. If the amount of data without missing value is not enough, data with missing value will be imputed. However, if there is no objective standard way to decide whether to delete the data with missing value. The data with missing value may be determined to be directly removed based on the decision involving subjective judgment of human, thereby leading to great challenges in interpreting rationality when reviewing clinical trials. Further, the data with missing value often contains unique information that is critical and vital to data analysis, if the data with missing value is directly removed without determination of subjective standard, thus resulting in the loss of clinical characteristic data. For example, when a patient drops out due to lack of efficacy reflected by a series of poor efficacy outcomes that have been observed, and missing values are introduced by discontinuation of the trial due to poor efficacy. On the other hand, data with missing values may be meaningless data, such as data filled in incorrectly by patients. As such, if the data with missing values is retained and further imputed with a filling value, it will cause distortion in clinical data analysis. Thus, if there is no objective standard to determine whether to delete or impute the missing value, it is difficult to explain the rationale for data collection, and analysis result distortion may be introduced. Thus, there is a need for improvement.

### SUMMARY OF THE INVENTION

It is therefore a primary objective of the present invention to provide a method of automatically processing missing value in data and a data processing system capable of determining the optimum filling value for data with missing value, in order to resolve the aforementioned problems.

The present invention discloses a method of automatically processing missing value in data, comprising: providing a data set comprising a plurality of data points and determining data points with missing value and data points without missing value in the data set; selecting the data points without missing value from the data set to form a first data subset without missing value; for each data point with missing value, iteratively performing a first outlier deletion operation to determine whether to delete or impute the data point with missing value based on the first data subset and a predetermined threshold value; and based on determining that the data point with missing value needs to be imputed, iteratively performing a second outlier deletion operation to determine an optimum filling value for the data points with missing value.

The present invention further discloses a data processing system, comprising: a database, for storing a data set, wherein the data set comprises a plurality of data points; and a processing circuit, coupled to the database, configured to obtain the data set and determine data points with missing value and data points without missing value in the data set, and select the data points without missing value from the data set to form a first data subset without missing value; wherein for each data point with missing value, the processing circuit is configured to iteratively perform a first outlier deletion operation to determine whether to delete or impute the data point with missing value based on the first data subset and a predetermined threshold value, and based on determining that the data point with missing value needs to be imputed, the processing circuit is configured to iteratively perform a second outlier deletion operation to determine an optimum filling value for the data points with missing value.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a data processing system according to an embodiment of the present invention.

FIG. 2 is a flow diagram of a procedure according to an embodiment of the present invention.

FIG. 3 is a flow diagram of a procedure for iteratively performing the first outlier deletion operation according to an embodiment of the present invention.

FIG. 4 is a schematic diagram illustrating the execution process of performing the first outlier deletion operation for the first time according to an embodiment of the present invention.

FIG. 5 is a schematic diagram illustrating the execution process of performing the first outlier deletion operation for the second time according to an embodiment of the present invention.

FIG. 6 is a schematic diagram illustrating the execution process of performing the first outlier deletion operation for the third time according to an embodiment of the present invention.

FIG. 7 is a flow diagram of a procedure for iteratively performing a second outlier deletion operation according to an embodiment of the present invention.

### DETAILED DESCRIPTION

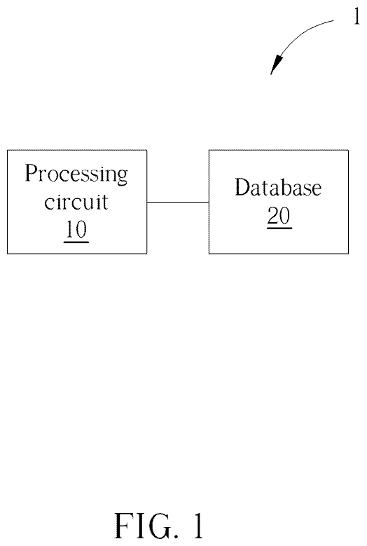

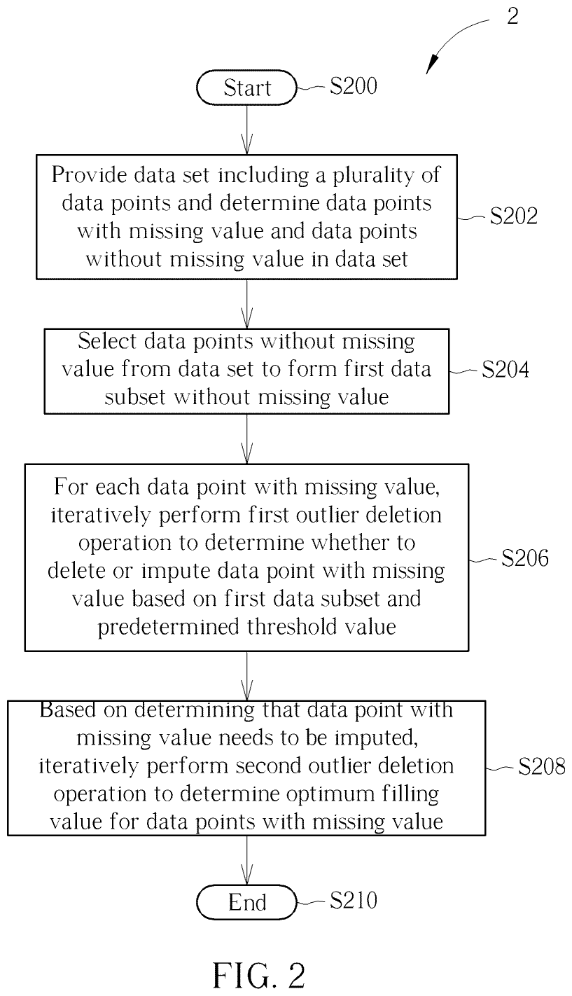

FIG. 1 is a schematic diagram of a data processing system 1 according to an embodiment of the present invention. Please refer to FIG. 1, which is a schematic diagram of a data processing system 1 according to an embodiment of the present invention. The data processing system 1 includes a processing circuit 10 and a database 20. The database 20 is utilized for storing a plurality of data sets. Each data set includes a plurality of data points (data subsets). The processing circuit 10 may access data sets stored in the database 20. The processing circuit 10 may also receive and process data sets from external devices. It is important to deal with missing values before analyzing data since ignoring or omitting missing values may result in biased or misinformed analysis. Therefore, the embodiments of the present invention provide a method of automatically processing missing value in data. Please refer to FIG. 2. FIG. 2 is a flow diagram of a procedure 2 according to an embodiment of the present invention. The procedure 2 includes the following steps:
Step S200: Start.
Step S202: Provide a data set including a plurality of data points and determine data points with missing value and data points without missing value in the data set.
Step S204: Select the data points without missing value from the data set to form a first data subset without missing value.
Step S206: For each data point with missing value, iteratively perform a first outlier deletion operation to determine whether to delete or impute the data point with missing value based on the first data subset and a predetermined threshold value.
Step S208: Based on determining that the data point with missing value needs to be imputed, iteratively perform a second outlier deletion operation to determine an optimum filling value for the data points with missing value.
Step S210: End.

According to the procedure 2, in Step S202, the processing circuit 10 may obtain a data set from the data base 20 or an external device. The data set includes a plurality of data points. After obtaining the data set, the processing circuit 10 may analyze the data set, and determine data points with missing value and data points without missing value in the data set. In Step S204, the processing circuit 10 may select the data points without missing value from the data set so as to form a first data subset without missing value. The first data subset includes at least one data point without missing value. For example, the processing circuit 10 selects all data points without missing values from the data set to form a first data subset without missing value.

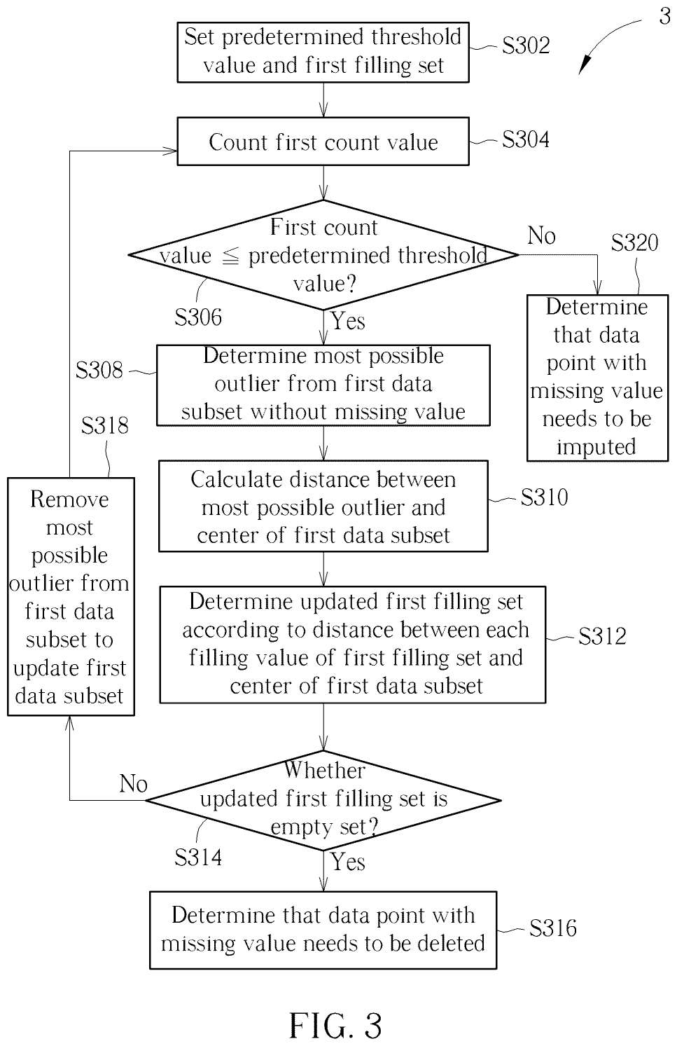

In Step S206, for each data point with missing value, the processing circuit 10 may iteratively perform a first outlier deletion operation to determine whether to delete or impute the data point with missing value based on the first data subset and a predetermined threshold value. Regarding operations of iteratively performing the first outlier deletion operation may be summarized in an exemplary procedure 3. Please refer to FIG. 3. FIG. 3 is a flow diagram of the procedure 3 for iteratively performing the first outlier deletion operation according to an embodiment of the present invention. The procedure 3 may be applied to determine whether the data point with missing value needs to be removed or imputed for each data point with missing value. In Step S302, the processing circuit 10 may set a predetermined threshold value. The processing circuit 10 may preset a predetermined threshold value. The processing circuit 10 may count a first count value. For example, the processing circuit 10 may utilize a counter to count and output the first count value. The initial value of the first count value may be set to zero (count1=0). In Step S302, for each data point with missing value, the processing circuit 10 may obtain a first filling set of the data point with missing value. The first filling set includes at least one qualified filling value (or called imputation value). The filling value may be utilized for performing imputation operations on the data point with missing value. The first filling set may include all qualified filling values for the data point with missing value. Each filling value in the first filling set may be utilized for performing an imputation operation on the corresponding data point with missing value. In Step S302, for each data point with missing value, the first filling set of the data point with missing value may be represented as FS (count1), wherein count1 represents the first count value. For example, the first count value is 0, FS(0)={all qualified filling values}.

In Step S304, each time the first outlier deletion operation is performed, the first count value is counted. Each time when Step S304 is entered, the processing circuit 10 may add 1 to the first count value. The first counter value is incremented by one each time Step S304 is entered. That is, each time Steps S304, S306, S308, S310, S312, S314 and S318 of the first outlier deletion operation are executed consecutively, and then Step S304 is entered so that the first counter value may be incremented by one. The first count value may be utilized for counting the number of times the first outlier deletion operation has been performed.

In Step S306, the processing circuit 10 may compare the first count value with the predetermined threshold value. When determining that the first count value is less than or equal to the predetermined threshold value, Step S308 is executed. When determining that the first count value is greater than the predetermined threshold value, Step S320 is executed. In Step S308, the processing circuit 10 may determine a most possible outlier from the first data subset without missing value based on determining that the first count value is less than or equal to the predetermined threshold value. For example, the processing circuit 10 may utilize any outlier detection or identification to determine an outlier from the data points in the first data subset for acting as the most possible outlier. For example, the processing circuit 10 may cluster the first data subset to generate a plurality of data groups. That is, the first data subset may be divided into a plurality of data groups. The processing circuit 10 may select a most possible outlier from data groups with the fewest number of data points. For example, the processing circuit 10 may cluster the first data subset to generate the plurality of data groups, and determine a most possible outlier according to the distance between each data point in the data group with the fewest number of data points and a reference data point.

In Step S310, the processing circuit 10 may determine a center of the first data subset. The center of the first data subset may be arithmetic mean, median or mode of all data points in the first data subset. The center of the first data subset may be the data point having the minimum summation of distances from other points in the first data subset. The center of the first data subset may be one of the data points in the first data subset. Moreover, the processing circuit 10 may calculate a distance between the most possible outlier determined at Step S308 and the center of the first data subset. Embodiments of the present invention may utilize any distance metric to calculate the distance. For example, the distance metric may be Euclidean distance, or any other distance metric, but not limited thereto.

In Step S312, for each data point with missing value, the processing circuit 10 may determine an updated first filling set according to the distance between the most possible outlier calculated in Step S310 and the center of the first data subset and distances between each filling value of a first filling set of the data point with missing value and the center of the first data subset. Each time the first outlier deletion operation is performed, the updated first filling set calculated in the last first outlier deletion operation may be inputted for acting as the first filling set for current first outlier deletion operation. For example, when the first outlier deletion operation is performed for the first time, the first filling set of the data point with missing value may be an initial first filling set, such as the first filling set FS(0) including all qualified filling values obtained in Step S302. In Step S312, for each data point with missing value, the processing circuit 10 may calculate the distance between each filling value of the first filling set of the data point with missing value and the center of the first data subset. The processing circuit 10 may compare the distance between each filling value of the first filling set and the center of the first data subset with the distance between the most possible outlier and the center of the first data subset calculated at Step S310. For each filling value of the first filling set, the processing circuit 10 may remove the filling value from the first filling set to form the updated first filling set when the distance between the filling value and the center of the first data subset is greater than or equal to the distance between the most possible outlier and the center of the first data subset. The processing circuit 10 may retain the filling value in the first filling set to form the updated first filling set when the distance between the filling value and the center of the first data subset is smaller than the distance between the most possible outlier and the center of the first data subset. The updated first filling set may be expressed as follows:

$$F S ( count 1 ) = \{ \hat{m} ∈ F S ( count 1 - 1 ) \vert {d}_{c} ( \hat{m} ) < {d}_{c} ( M P O ) \} \qquad ( 1 )$$

where FS(count1) represents the updated first filling set, d_{c}(\hat{m}) represents the distance between the filling value \hat{m} and the center of the first data subset, d_{c}(MPO) represents the distance between the most possible outlier MPO and the center of the first data subset.

In Step S314, the processing circuit 10 may determine whether the updated first filling set of the data point with missing value is an empty set. The processing circuit 10 may calculate the number of filling values in the updated first filling set of the data points with missing values to determine whether there is still a filling value in the updated first filling set. When determining that the number of filling values in the updated first filling set is greater than zero (i.e., the updated first filling set includes at least one filling value), the processing circuit 10 may determine that the updated first filling set of the data point with missing value is not an empty set, and Step S318 is executed. When determining that the number of filling values in the updated first filling set is greater than zero, this means that the data point with missing value still has corresponding filling values. As such, the data point with missing value may be imputed by using the filling value of the updated first filling set, and thus the imputed data point will not be an outlier. Therefore, through the determination and processing operations of Steps S314 and S318, the method of the embodiments of the present invention may ensure that when the data point with missing value is imputed by using the filling value of the updated first filling set, the imputed data point does not belong to any outlier. Furthermore, in Step S318, the processing circuit 10 may remove the most possible outlier determined at Step S308 from the first data subset for updating the first data subset. After that, the procedure returns to Step S304, and thus the next first outlier deletion operation is performed. Such like this, the first outlier deletion operation may be performed iteratively and recursively. In Step S308, the most possible outlier that is removed from the first data subset may be represented as MPO(i), where i represents the number of times the first outlier deletion operation is executed (i.e., the i-th execution of the first outlier deletion operation). The most possible outlier to be removed from the first data subset may be referred to as most possible outlier with order i (or called i-order most possible outlier).

In Step S314, when determining that the number of filling values in the updated first filling set is zero (i.e., there is no filling value in the updated first filling set), the processing circuit 10 may determine that the updated first filling set of the data point with missing value is an empty set, and Step S316 is executed. In such a situation, since there is no filling value in the updated first filling set, no matter what filling value is utilized to impute the data point with missing value, the imputed data point belongs to one of the outliers that are previously removed. Therefore, in Step S316, the processing circuit 10 may determine that the data point with missing value needs to be deleted from the data set. As such, the data point with missing value may be removed from the data set by the processing circuit 10. In addition, the processing circuit 10 may determine and output the updated first filling set generated in the previous first outlier deletion operation as the optimum filling value for the data points with missing value.

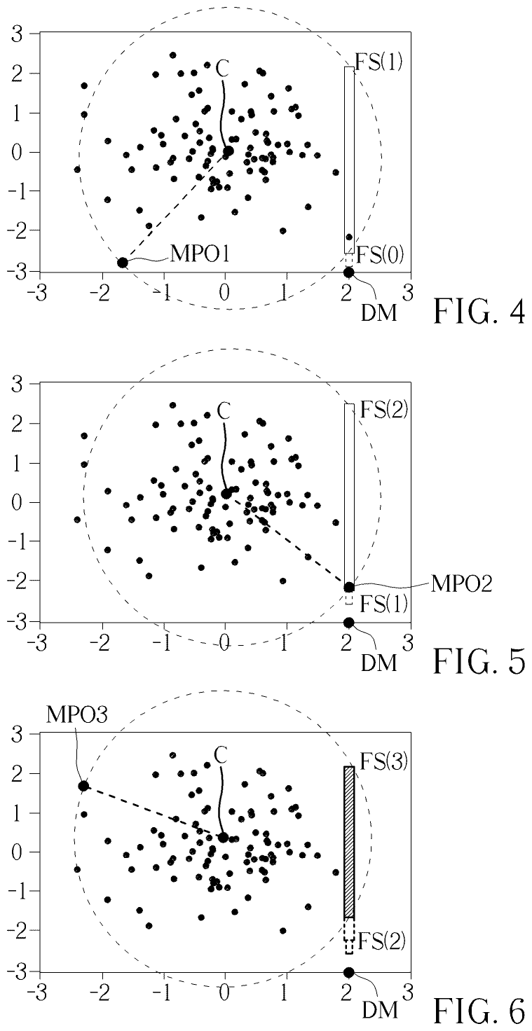

In other words, during each execution of the first outlier deletion operation, the processing circuit 10 may determine the updated first filling set for the data point with missing value according to the distance between the most possible outlier and the center of the first data subset and the distance between current filling values of the first filling set and the center of the first data subset. For example, taking a data point DM with missing value as an example, please refer to FIG. 4. FIG. 4 is a schematic diagram illustrating the execution process of performing the first outlier deletion operation performed for the first time according to an embodiment of the present invention. As shown in FIG. 4, the solid circles represent the data points of the data set. A most possible outlier MPO1 is determined from the first data subset without missing value (in Step S308) while performing the first outlier deletion operation for the first time. The center C of the first data subset is represented. Since the first outlier deletion operation is performed for the first time (i.e. first execution of first outlier deletion operation), the processing circuit 10 may obtain the initial first filling set FS(0) for acting as the first filling set to be utilized for this operation, i.e. the first execution of first outlier deletion operation. For each filling value of the first filling set FS(0), the processing circuit 10 may calculate the distance between the filling value and the center C. When determining that the distance between the filling value and the center C is greater than or equal to the distance between the most possible outlier MPO1 and the center C, the processing circuit 10 may remove the filling value from the first filling set FS(0) to form an updated first filling set FS(1). As shown in FIG. 4, a circle (dashed circle in FIG. 4) is formed with the center C of the first data subset as the center and with the distance from the center C and the most possible outlier MPO1 as the radius. The processing circuit 10 may remove the filling values located on and outside the circle from the first filling set FS(0), and retains the filling values within the circle so as to form an updated first filling set FS(1).

Please refer to FIG. 5 and FIG. 6. FIG. 5 is a schematic diagram illustrating the execution process of performing the first outlier deletion operation performed for the second time according to an embodiment of the present invention. FIG. 6 is a schematic diagram illustrating the execution process of performing the first outlier deletion operation performed for the third time according to an embodiment of the present invention. As shown in FIG. 5, a most possible outlier MPO2 is determined from the first data subset without missing value (in Step S308) while performing the first outlier deletion operation for the second time (i.e. second execution of first outlier deletion operation). Since the first outlier deletion operation is performed for the second time (i.e. second execution of first outlier deletion operation), the processing circuit 10 may obtain the updated first filling set FS(1) generated by the previous operation (first execution of first outlier deletion operation) for acting as the first filling set to be utilized for this operation (i.e. second execution of first outlier deletion operation). For each filling value of the first filling set (updated first filling set FS(1)), when determining that the distance between the filling value and the center C is greater than or equal to the distance between the most possible outlier MPO2 and the center C, the processing circuit 10 may remove the filling value from the first filling set (updated first filling set FS(1)) to form an updated first filling set FS(2). As shown in FIG. 5, the processing circuit 10 may remove the filling values located on and outside the circle from the first filling set (updated first filling set FS(1)), and retains the filling values within the circle so as to form an updated first filling set FS(2). Such like this, as shown in FIG. 6, a most possible outlier MPO3 is determined from the first data subset without missing value (in Step S308) while performing the first outlier deletion operation for the third time (i.e. third execution of first outlier deletion operation). The processing circuit 10 may obtain the updated first filling set FS(2) generated by the previous operation (second execution of first outlier deletion operation) for acting as the first filling set to be utilized for this operation (i.e. third execution of first outlier deletion operation). As shown in FIG. 6, the processing circuit 10 may remove the filling values located on and outside the circle from the first filling set (updated first filling set FS(2)), and retains the filling values within the circle so as to form an updated first filling set FS(3). Therefore, after performing the first outlier deletion operation three times, the filling values for the data point DM with the missing value may be reduced from the filling set FS(1) to the filling set FS(3).

In Step S320, when determining that the first count value is greater than the predetermined threshold value, this means that the number of times of performing the first outlier deletion operation is greater than the predetermined threshold value, and the processing circuit 10 may determine that the data point with missing value may be imputed with the filling value. The processing circuit 10 may select any filling value from all the qualified filling values to perform an imputation operation on the data point with missing value, and the imputed data point with missing value may not become an outlier. During iteratively performing the first outlier deletion operation in the procedure 3, if there is no corresponding filling value in the updated first filling set before the number of times that the first outlier deletion operation has been performed reaches a predetermined number of times, this means that the data point with missing value needs to be deleted. When the number of times that the first outlier deletion operation has been performed reaches the predetermined number of times and the updated first filling set still has corresponding filling values for the data point with missing value, this means that the data point with missing value may be imputed with the filling value.

In addition, in step S320, the processing circuit 10 may decrement the current first count value by one to generate a second count value, and output the second count value. The second count value represents the number of times that the first outlier deletion operation has been performed. The second count value may be equal to the predetermined threshold value. That is, the processing circuit 10 has repeatedly performed the first outlier deletion operation a first number of times (e.g., the number of times of performing the first outlier deletion operation is equal to the predetermined threshold value). Therefore, a first number of data points to be determined as the most possible outliers have been removed from the first data subset so that the updated first data subset is formed. The processing circuit 10 may determine the updated first data subset generated in the previous execution of the first outlier deletion operation as a second data subset. In addition, the processing circuit 10 may also determine the updated first filling set generated in the previous execution of the first outlier deletion operation as a second filling set. For example, the predetermined threshold value is k, and the processing circuit 10 determines the updated first data subset generated after performing the first outlier deletion operation for the k-th time as the second data subset. The processing circuit 10 determines the updated first filling set generated after performing the first outlier deletion operation for the k-th time as the second filling set. The processing circuit 10 may output the second count value, the second data subset and the second filling set as initial input values for the subsequent second outlier deletion operation.

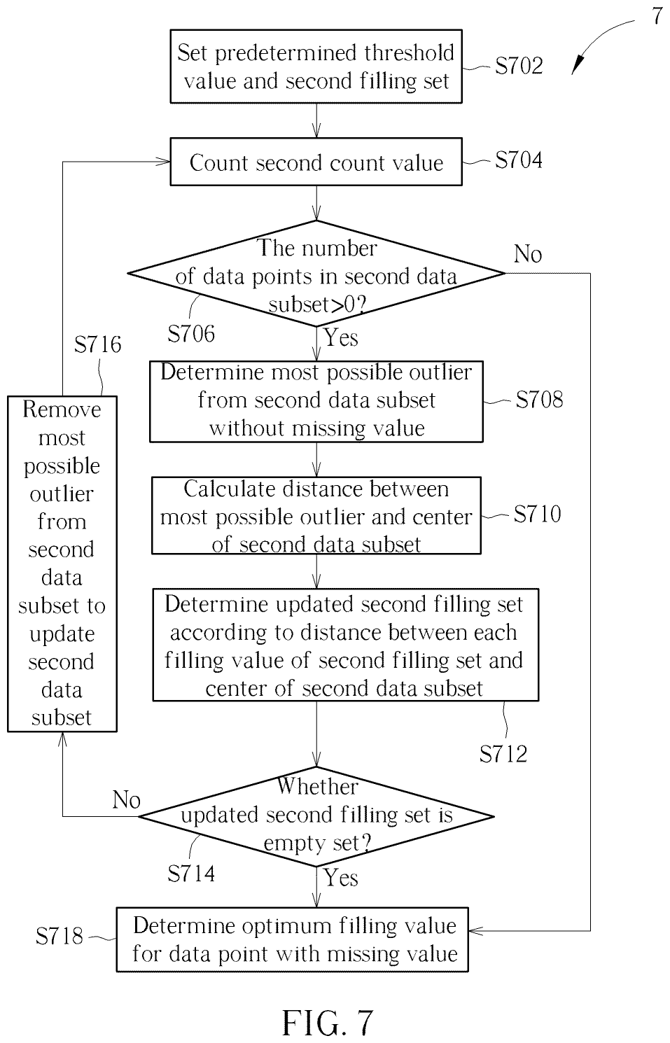

In Step S208, based on determining that the data point with missing value needs to be imputed, the processing circuit 10 may iteratively perform a second outlier deletion operation to determine optimum filling values for the data point with missing value. Regarding the operations of iteratively performing the second outlier deletion operation may be summarized in an exemplary procedure 7. Please refer to FIG. 7. FIG. 7 is a flow diagram of a procedure 7 for iteratively performing a second outlier deletion operation according to an embodiment of the present invention. The procedure 7 may be applied to determine an optimum filling value for each data point with missing value. In Step S702, since the first outlier deletion operation has repeatedly performed a first number of times in Step S206, the processing circuit 10 may obtain a second data subset associated with the updated first data subset and a second filling set associated with the updated first filling set. In Step S702, the processing circuit 10 may utilize a counter to count and output a second count value. The initial value of the second count value may be set to the predetermined threshold value used in step S306 (count2=predetermined threshold value k) by the processing circuit 10. For each data point with missing value, the processing circuit 10 may obtain a second data subset associated with the updated first data subset. The second data subset may be the updated first data subset generated after iteratively performing the first outlier deletion operation. For example, the second data subset may be the updated first data subset generated when performing the first outlier deletion operation for the last time (e.g., the k-th time) in procedure 3. For each data point with missing value, the processing circuit 10 may obtain a second filling set for the data point with missing value. The second filling set may be the updated first filling set generated after iteratively performing the first outlier deletion operation. Each filling value in the second filling set may be utilized for performing an imputation operation on the corresponding data point with missing value. For example, the second filling set may be the updated first filling set generated when performing the first outlier deletion operation for the last time (e.g., the k-th time) in procedure 3. The second filling set of the data point with missing value may be represented as FS(count2), wherein count2 represents the second count value. For example, the second count value is k, FS(k)={all qualified filling values}.

In Step S704, each time the second outlier deletion operation is performed, the second count value is counted. Each time when Step S704 is entered, the processing circuit 10 may add 1 to the second count value. The second counter value is incremented by one each time Step S704 is entered. In Step S706, the processing circuit 10 may calculate the number of data points in the second data subset. When determining that the number of data points in the second data is greater than zero, Step S708 is executed. When determining that the number of data points in the second data is zero, Step S718 is executed. In Step S708, the processing circuit 10 may determine a most possible outlier from the second data subset without missing value. For example, the processing circuit 10 may utilize any outlier detection or identification to determine an outlier from the data points in the second data subset for acting as the most possible outlier. Steps S708, S710, S712, S714 and S716 are similar to Steps S308, S310, S312, S314 and S318.

In Step S710, the processing circuit 10 may determine a center of the second data subset. The center of the second data subset may be arithmetic mean, median or mode of all data points in the second data subset. The center of the second data subset may be the data point having the minimum summation of distances from other points in the second data subset. The center of the second data subset may be one of the data points in the second data subset. Moreover, the processing circuit 10 may calculate a distance between the most possible outlier determined at Step S708 and the center of the second data subset.

In Step S712, for each data point with missing value, the processing circuit 10 may determine an updated second filling set according to the distance between the most possible outlier calculated in Step S708 and the center of the second data subset and distances between each filling value of a second filling set of the data point with missing value and the center of the second data subset. Each time the second outlier deletion operation is performed, the updated second filling set calculated in the last second outlier deletion operation may be inputted for acting as the second filling set for current second outlier deletion operation. For example, when the second outlier deletion operation is performed for the first time, the second filling set of the data point with missing value may be an initial second filling set, such as the second filling set FS(k) obtained in Step S702.

In Step S712, for each data point with missing value, the processing circuit 10 may calculate the distance between each filling value of a second filling set of the data point with missing value and the center of the second data subset. The processing circuit 10 may compare the distance between each filling value of the second filling set and the center of the second data subset with the distance between the most possible outlier calculated in Step S710 and the center of the second data subset. For each filling value of the second filling set, the processing circuit 10 may remove the filling value from the second filling set to form the updated second filling set when the distance between the filling value and the center of the second data subset is greater than or equal to the distance between the most possible outlier and the center of the second data subset. The processing circuit 10 may retain the filling value in the second filling set to form the updated second filling set when the distance between the filling value and the center of the second data subset is smaller than the distance between the most possible outlier and the center of the second data subset. The updated second filling set may be expressed as follows:

$$F S ( count 2 ) = \{ \hat{m} ∈ F S ( count 2 - 1 ) \vert {d}_{c} ( \hat{m} ) < {d}_{c} ( M P O ) \} \qquad ( 2 )$$

where FS(count2) represents the updated second filling set, d_{c}(\hat{m}) represents the distance between the filling value \hat{m} and the center of the second data subset, d_{c}(MPO) represents the distance between the most possible outlier and the center of the second data subset.

In Step S714, the processing circuit 10 may determine whether the updated second filling set of the data point with missing value is an empty set. The processing circuit 10 may determine whether there is still a filling value in the updated second filling set. The processing circuit 10 may calculate the number of filling values in the updated second filling set of the data points with missing values to determine whether there is still a filling value in the updated second filling set. When determining that the number of filling values in the updated second filling set is greater than zero (i.e., the updated second filling set includes at least one filling value), the processing circuit 10 may determine that the updated second filling set of the data point with missing value is not an empty set, and Step S716 is executed. When determining that the number of filling values in the updated second filling set is zero (i.e., there is no filling value in the updated second filling set), the processing circuit 10 may determine that the updated second filling set of the data point with missing value is an empty set, and Step S718 is executed.

In Step S716, when determining that the number of filling values in the updated second filling set is greater than zero, this means that the data point with missing value still has corresponding filling values. As such, the data point with missing value may be imputed by using the filling value of the updated second filling set, and the imputed data point will not be an outlier. Therefore, the processing circuit 10 may remove the most possible outlier determined at Step S708 from the second data subset for updating the second data subset. After that, the procedure returns to Step S704, and thus the next second outlier deletion operation is performed. Such like this, the second outlier deletion operation may be performed iteratively and recursively.

In Step S718, when determining that the number of filling t values in the updated second filling set is zero, the processing circuit 10 may determine the updated second filling set generated by the previous second outlier deletion operation as optimum filling values of the data point with missing value. In addition, when this iteration operation is the first time to perform the second outlier deletion operation, the processing circuit 10 may determine the second filling set obtained in Step S702 as the optimum filling values of the data point with missing value. In other words, through iteratively and recursively performing the second outlier deletion operation of the embodiments of the present invention, when the number of times that the second outlier deletion operation is executed reaches a predetermined number of times and the updated second filling set still has corresponding filling values, this means that the filling values in the updated second set are indeed the optimum and appropriate filling values, thus reducing the risk of errors and bias in data analysis. However, regarding the traditional method for processing data with missing value, the more feature fields in the data with missing value, the easier the data with missing value is determined to be deleted and discarded. For example, missing values may often occur in medical clinical trials while the patients drop out of a trial due to lack of efficacy. In such a situation, the data with missing value often contains unique information that is critical and vital to data analysis. Compared with the conventional method, the embodiments of the present invention may determine to remove data with missing value based on determining whether the data is still an outlier after imputation operation, rather than based on the number of feature fields of missing value in data. The embodiments of the present invention provide the method of automatically processing missing values in data, which can effectively avoid the distortion and bias in analysis results. The embodiments of the present invention merely have to ensure whether the number of data without missing value is enough to reflect the clinical manifestations. More particularly, the embodiments of the present invention determine to remove data with missing value based on determining whether the data with missing value is still an outlier after imputation operation rather than based on the number of feature fields of missing value in data. Through iteratively performing the outlier deletion operation, the embodiments of the present invention may utilized the filling set and outlier determination to ensure that the data with missing value would not become outliers after imputation, and the method of the embodiments of the present invention may be effectively applied in data analysis for medical clinical trials.

Those skilled in the art should readily make combinations, modifications and/or alterations on the abovementioned description and examples. The abovementioned description, steps, procedures and/or processes including suggested steps can be realized by means that could be hardware, software, firmware (known as a combination of a hardware device and computer instructions and data that reside as read-only software on the hardware device), an electronic system, the data processing system 1 or combination thereof. Examples of hardware can include analog, digital and/or mixed circuits known as microcircuit, microchip, or silicon chip. For example, the hardware may include application-specific integrated circuit (ASIC), field programmable gate array (FPGA), programmable logic device, coupled hardware components or combination thereof. In another example, the hardware may include general-purpose processor, microprocessor, controller, digital signal processor (DSP) or combination thereof. Examples of the software may include set(s) of codes, set(s) of instructions and/or set(s) of functions retained (e.g., stored) in a storage device, e.g., a non-transitory computer-readable medium. The non-transitory computer-readable storage medium may include read-only memory (ROM), flash memory, random access memory (RAM), subscriber identity module (SIM), hard disk, floppy diskette, or CD-ROM/DVD-ROM/BD-ROM, but not limited thereto. The data processing system 1 of the embodiments of the invention may include the processing circuit 10 and a storage device. Any of the abovementioned procedures and examples above may be compiled into program codes or instructions that are stored in the storage device or a computer-readable medium. The processing circuit 10 may read and execute the program codes or the instructions stored in the storage device or computer-readable medium for realizing the abovementioned functions.

In summary, the embodiments of the present invention provide a method of automatically processing missing values in data, which is capable of effectively simplifying the process of analyzing and reviewing experimental data of clinical trial, accelerating the implementation of smart healthcare research and development technology in application scenarios, and realizing a consistent and automatic process for handling missing values in clinical experiments, and thus effectively reducing the company's investment in clinical trial data analysis.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of automatically processing missing value in data, comprising:
providing a data set comprising a plurality of data points and determining data points with missing value and data points without missing value in the data set;
selecting the data points without missing value from the data set to form a first data subset without missing value;
for each data point with missing value, iteratively performing a first outlier deletion operation to determine whether to delete or impute the data point with missing value based on the first data subset and a predetermined threshold value; and
based on determining that the data point with missing value needs to be imputed, iteratively performing a second outlier deletion operation to determine an optimum filling value for the data points with missing value.

2. The method of claim 1, wherein the step of for each data point with missing value iteratively performing the first outlier deletion operation to determine whether to delete or impute the data point with missing value based on the first data subset and a predetermined threshold value comprising:
counting a first count value when performing the first outlier deletion operation each time;
comparing the first count value with the predetermined threshold value, and when determining that the first count value is less than or equal to the predetermined d threshold value, determining a most possible outlier from the first data subset;
determining a center of the first data subset and calculating a distance between the most possible outlier and the center of the first data subset;
determining an updated first filling set according to the distance between the most possible outlier and the center of the first data subset and distances between each filling value of a first filling set of the data point with missing value and the center of the first data subset; and
determining whether to delete the data point with missing value according to the number of filling values in the first filling set.

3. The method of claim 2, wherein the step of determining the updated first filling set according to the distance between the most possible outlier and the center of the first data subset and distances between each filling value of the first filling set of the data point with missing value and the center of the first data subset comprising:
for each filling value of the first filling set, calculating a distance between the filling value and the center of the first data subset; and
removing the filling value from the first filling set to form the updated first filling set when the distance between the filling value and the center of the first data subset is greater than or equal to the distance between the most possible outlier and the center of the first data subset.

4. The method of claim 2, wherein the step of determining whether to delete the data point with missing value according to the number of filling values in the first filling set comprising:
when determining that the number of filling values in the updated first filling set is zero, determining that the data point with missing value needs to be deleted from the data set; and
when determining that the number of filling values in the updated first filling set is greater than zero, removing the most possible outlier from the first data subset to form an updated first data subset and performing the next first outlier deletion operation.

5. The method of claim 1, wherein the step of for each data point with missing value iteratively performing the first outlier deletion operation to determine whether to delete or impute the data point with missing value based on the first data subset and a predetermined threshold value comprising:
counting a first count value when performing the first outlier deletion operation each time;
comparing the first count value with the predetermined threshold value, and when determining that the first count value is greater than the predetermined threshold value, determining that the data point with missing value needs to be imputed;
decrementing the first count value by one to generate a second count value and outputting the second count value; and
outputting the updated first data subset as a second data subset and outputting the updated first filling set as a second filling set.

6. The method of claim 1, wherein the step of based on determining that the data point with missing value needs to be imputed iteratively performing the second outlier deletion operation to determine an optimum filling value for the data points with missing value comprising:
obtaining a second data subset associated with the first data subset, wherein the second data subset is the updated first data subset generated after iteratively performing the first outlier deletion operation;
counting a second count value when performing the second outlier deletion operation each time;
calculating the number of data points in the second data subset, and determining a most possible outlier from the second data subset when determining that the number of data points in the second data is greater than zero;
determining a center of the second data subset and calculating a distance between the most possible outlier and the center of the second data subset;
determining an updated second filling set according to the distance between the most possible outlier and the center of the second data subset and distances between each filling value of a second filling set of the data point with missing value and the center of the second data subset;
calculating the number of filling values in the updated second filling set, and when determining that the number of filling values in the updated second filling set is zero, determining that the updated second filling set determined in the previous second outlier deletion operation as the optimum filling value for the data points with missing value; and
when determining that the number of filling values in the updated second filling set is greater than zero, removing the most possible outlier from the second data subset to form an updated second data subset and performing the next second outlier deletion operation.

7. The method of claim 6, wherein the step of determining the updated second filling set according to the distance between the most possible outlier and the center of the second data subset and distances between each filling value of the second filling set of the data point with missing value and the center of the second data subset comprising:
for each filling value of the second filling set, calculating a distance between the filling value and the center of the second data subset; and
removing the filling value from the second filling set to form the updated second filling set when the distance between the filling value and the center of the second data subset is greater than or equal to the distance between the most possible outlier and the center of the second data subset.

8. A data processing system, comprising:
a database, for storing a data set, wherein the data set comprises a plurality of data points; and
a processing circuit, coupled to the database, configured to obtain the data set and determine data points with missing value and data points without missing value in the data set, and select the data points without missing value from the data set to form a first data subset without missing value;
wherein for each data point with missing value, the processing circuit is configured to iteratively perform a first outlier deletion operation to determine whether to delete or impute the data point with missing value based on the first data subset and a predetermined threshold value, and based on determining that the data point with missing value needs to be imputed, the processing circuit is configured to iteratively perform a second outlier deletion operation to determine an optimum filling value for the data points with missing value.

9. The data processing system of claim 8, wherein the processing circuit is configured to count a first count value when performing the first outlier deletion operation each time, the processing circuit is configured to compare the first count value with the predetermined threshold value, and when determining that the first count value is less than or equal to the predetermined threshold value, the processing circuit is configured to determine a most possible outlier from the first data subset, the processing circuit is configured to determine a center of the first data subset and calculating a distance between the most possible outlier and the center of the first data subset, the processing circuit is configured to determine an updated first filling set according to the distance between the most possible outlier and the center of the first data subset and distances between each filling value of a first filling set of the data point with missing value and the center of the first data subset, and the processing circuit is configured to determine whether to delete the data point with missing value according to the number of filling values in the first filling set.

10. The data processing system of claim 9, wherein for each filling value of the first filling set, the processing circuit is configured to calculate a distance between the filling value and the center of the first data subset, and the processing circuit is configured to remove the filling value from the first filling set to form the updated first filling set when the distance between the filling value and the center of the first data subset is greater than or equal to the distance between the most possible outlier and the center of the first data subset.

11. The data processing system of claim 9, wherein when determining that the number of filling values in the updated first filling set is zero, the processing circuit is configured to determine that the data point with missing value needs to be deleted from the data set, and when determining that the number of filling values in the updated first filling set is greater than zero, the processing circuit is configured to remove the most possible outlier from the first data subset to form an updated first data subset for performing the next first outlier deletion operation.

12. The data processing system of claim 8, wherein the processing circuit is configured to count a first count value when performing the first outlier deletion operation each time, the processing circuit is configured to compare the first count value with the predetermined threshold value, when determining that the first count value is greater than the predetermined threshold value, the processing circuit is configured to determine that the data point with missing value needs to be imputed, the processing circuit is configured to decrement the first count value by one to generate a second count value and output the second count value, and the processing circuit is configured to output the updated first data subset as a second data subset and output the updated first filling set as a second filling set.

13. The data processing system of claim 8, wherein the processing circuit is configured to obtain a second data subset associated with the first data subset, wherein the second data subset is the updated first data subset generated after iteratively performing the first outlier deletion operation, the processing circuit is configured to count a second count value when performing the second outlier deletion operation each time, the processing circuit is configured to calculate the number of data points in the second data subset and determine a most possible outlier from the second data subset when determining that the number of data points in the second data is greater than zero, the processing circuit is configured to determine a center of the second data subset and calculate a distance between the most possible outlier and the center of the second data subset, the processing circuit is configured to determine an updated second filling set according to the distance between the most possible outlier and the center of the second data subset and distances between each filling value of a second filling set of the data point with missing value and the center of the second data subset, the processing circuit is configured to calculate the number of filling values in the updated second filling set, and when determining that the number of filling values in the updated second filling set is zero, the processing circuit is configured to determine that the updated second filling set determined in the previous second outlier deletion operation as the optimum filling value for the data points with missing value, and when determining that the number of filling values in the updated second filling set is greater than zero, the processing circuit is configured to remove the most possible outlier from the second data subset to form an updated second data subset for performing the next second outlier deletion operation.

14. The data processing system of claim 13, wherein for each filling value of the second filling set, the processing circuit is configured to calculate a distance between the filling value and the center of the second data subset, and the processing circuit is configured to remove the filling value from the second filling set to form the updated second filling set when the distance between the filling value and the center of the second data subset is greater than or equal to the distance between the most possible outlier and the center of the second data subset.
